(19) United States
(12) Patent Application Publication
(10) Pub. No.: US 2012/0091807 A1
(43) Pub. Date: Apr. 19, 2012

(54) METHOD AND APPARATUS FOR DISCHARGING THE CAPACITORS OF A BOOST CONVERTER COMPOSED OF PLURAL BRIDGE DEVICES

(75) Inventors: Gustavo Buiatti, Rennes Cedex (FR); Laurent Foube, Rennes Cedex (FR)

(73) Assignee: Mitsubishi Electric Corporation, Tokyo (JP)

(21) Appl. No.: 13/265,342

(22) PCT Filed: Apr. 22, 2010
(86) PCT No.: PCT/EP2010/055316

§ 371 Date: Nov. 28, 2011

(30) Foreign Application Priority Data
Apr. 23, 2009 (EP) 09158623.0

(51) Int. Cl. H02M 3/07; H02J 1/00

(52) U.S. Cl. 307/43; 363/60

(57) ABSTRACT

The present invention concerns a method for discharging the capacitors of a boost converter composed of a number n of bridge devices connected in series, the boost converter is connected to electric direct current providing means, each bridge device is composed of plural switches and a capacitor. The method comprises the steps of setting the switches of the bridge devices in n−1 different configurations in order to discharge the capacitors of n−1 different bridge devices within n−1 consecutive periods of time.

The present invention relates generally to a method and an apparatus for discharging the capacitors of a boost converter composed of plural bridge devices.

Classical DC/DC converters use inductors in order to convert a direct current from a first voltage to a second voltage which may be larger or smaller than the first voltage.

Inductors are used for storing energy in the form of magnetic field (current) and they have many drawbacks. Inductors are heavy, their cost is relatively important because they are mainly composed of copper material.

The combination of switches and capacitors in order to replace inductors has been already proposed.

For example, charge pumps, also known as DC/DC converters use capacitors as energy storage elements. When compared to inductive switching DC/DC converters, which also use inductors as energy storage elements, charge pumps offer unique characteristics that make them attractive for certain end-user applications.

When boost converters operate, the capacitors of the boost converters are charged.

In order to allow the setting of the boost converters to known initial conditions or for maintenance reasons, it is sometimes necessary to discharge the capacitors of the boost converters.

Because the capacitors can store a large amount of charge at relatively high DC voltages such as at 240 volts and higher, the capacitors must be discharged when the power source is removed or disconnected from the boost converter in order to comply with safety standards to prevent any capacitor from generating a shock hazard to a service man or an operator. The IEC 950 standard or CENELEC EN60950 requires the capacitors to be discharged to a safe charge level which is a voltage level of less than 2 volts.

One solution could be to add, to each capacitor, parallel resistors in order to enable the discharge of the capacitors.

Such solution is not satisfactory in terms of power losses and cost. The parallel resistors continually dissipate power during the normal operation of the boost converter resulting in wasted energy which appears as heat in the power system.

Also, according to the IEC 950 standard recommendations, the capacitors must reach the safe voltage level in a short time, either one second or ten seconds depending upon how the power is connected. Since boost converters make use of high capacitance values, the parallel resistors suited for respecting the IEC 950 standard will lead to high power losses as high resistor values cannot be compatible with the short discharge time requirements.

Finally, the high number of capacitors in the boost converter would call for the need of the same number of parallel resistors to be used, also resulting in an expensive and voluminous solution.

The present invention aims to provide a satisfactory solution in terms of power losses, volume and cost.

To that end, the present invention concerns a method for discharging the capacitors of a boost converter composed of a number n of bridge devices connected in series, the boost converter composed of n bridge devices being connected to electric direct current providing means, each bridge device being composed of plural switches and a capacitor, characterised in that the method comprises the steps of:

setting the switches of the bridge devices in n-1 different configurations in order to discharge the capacitors of n-1 different bridge devices within n-1 consecutive periods of time.

The present invention concerns also an apparatus for discharging the capacitors of a boost converter composed of a number n of bridge devices connected in series, the boost converter composed of n bridge devices being connected to electric direct current providing means, each bridge device being composed of plural switches and a capacitor, characterised in that the apparatus comprises:

means for setting the switches of the bridge devices in n-1 different configurations in order to discharge the capacitors of n-1 different bridge devices within n-1 consecutive periods of time.

Thus, it is possible to discharge the capacitors of the boost converter composed of n bridge devices without needing a discharge resistor for every capacitor.

The cost of the boost converter composed of n bridge devices is minimized as its size.

There is no danger when someone is in contact with the capacitors of the boost converter composed of n bridge devices.

Furthermore, at anytime, the voltage on the capacitors of the boost converter composed of n bridge devices can be controlled. It is then possible to set initial conditions when the boost converter composed of n bridge devices is put into operation.

According to a particular feature, the boost converter composed of n bridge devices further comprises an output stage composed of at least a diode, an output capacitor, a discharge resistor and a discharge switch and the switches of the bridge devices and the discharge switch are set in a n^{th} configuration in order to discharge the output capacitor within a n^{th} time period.

Thus, it is possible to discharge the output capacitor of the boost converter composed of n bridge devices without needing a dedicated resistor for the output capacitor.

The cost of the boost converter composed of n bridge devices is minimized as its size.

There is no danger when someone is in contact with the output capacitor.

According to a particular feature, the n^{th} configuration further enables the discharge within the n^{th} time period of the capacitor of the n^{th} bridge device connected to the output stage.

Thus, it is possible to discharge the capacitor of the n^{th} bridge device of the boost converter composed of n bridge devices without needing a dedicated resistor for the capacitor of the n^{th} bridge device.

The cost of the boost converter composed of n bridge devices is minimized as its size.

There is no danger when someone is in contact with the capacitor of the n^{th} bridge device.

According to a particular feature, the boost converter composed of n bridge devices further comprises an input stage composed of at least an input diode, an input capacitor and an input resistor, and the switches of the bridge devices and the discharge switch are set in a (n+1)^{th} configuration in order to discharge the input capacitor within a (n+1)^{th} time period.

Thus, it is possible to discharge the input capacitor of the boost converter composed of n bridge devices without needing a resistor dedicated to the input capacitor.

The cost of the boost converter composed of n bridge devices is minimized as its size.

There is no danger when someone is in contact with the input capacitor. According to a particular feature, the n^{th} configuration is set as first, followed by the (n+1)^{th} configuration and followed by the other n-1 different configurations.

According to a particular feature, each switch of each bridge device is composed of a N-MOSFET transistor and its intrinsic body diode, the anode of the body diode is connected to the source of the N-MOSFET and the cathode of the body diode is connected to the drain of the N-MOSFET transistor.

According to a particular feature, the boost converter composed of n bridge devices further comprises a switch connecting the electric direct current providing means and the input stage and the switch connecting the electric direct current providing means and the input stage is in a non conducting state during the n+1 configurations.

Thus, the electric direct current providing means is not short circuited during the different configurations.

According to a particular feature, the electric direct current providing means are photovoltaic modules.

According to a particular feature, the boost converter composed of n bridge devices further comprises a switch connecting the photovoltaic modules and the input stage and the switch connecting the photovoltaic modules and the input stage is in conducting state during the n+1 configurations.

Thus, if photovoltaic modules without anti-parallel protection diodes are used, no additional device for the discharge process is needed.

According to a particular feature, the boost converter composed of n bridge devices further comprises a discharge circuit connected between the switch connecting the electric direct current providing means and the first bridge device, the discharge circuit being composed of a discharge diode and a second discharge resistor, the cathode of the discharge diode being connected to the input of the first bridge device, the anode of the discharge diode being connected to a first terminal of the second discharge resistor and the second terminal of the second discharge resistor being connected to the negative terminal of the electric direct current providing means.

Thus, there is a path for discharging at least one capacitor of the boost converter composed of n bridge devices when the electric direct current providing means are disconnected from the boost converter composed of n bridge devices and the voltage between the input of the first bridge device and the negative terminal of the electric direct current providing means becomes negative.

The characteristics of the invention will emerge more clearly from a reading of the following description of an example embodiment, the said description being produced with reference to the accompanying drawings, among which:

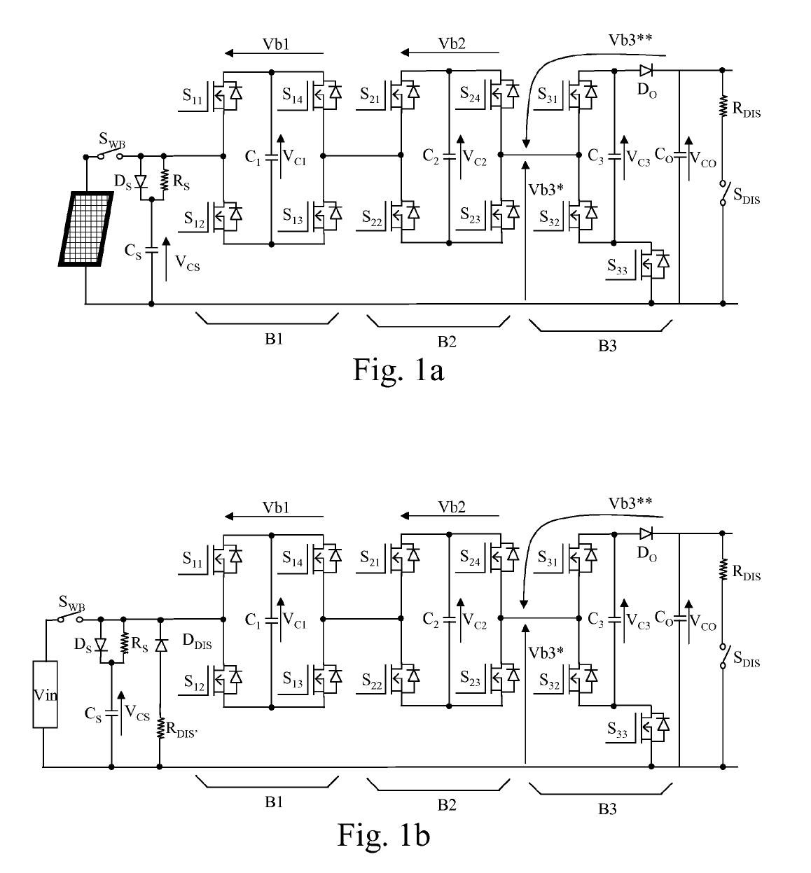

FIG. 1a represents a first example of a boost converter composed of three bridge devices and wherein the electric direct current providing means are photovoltaic modules without anti-parallel protection diodes;

FIG. 1b represents a second example of a boost converter composed of three bridge devices and wherein the electric direct current providing means are any kind of electric DC power sources;

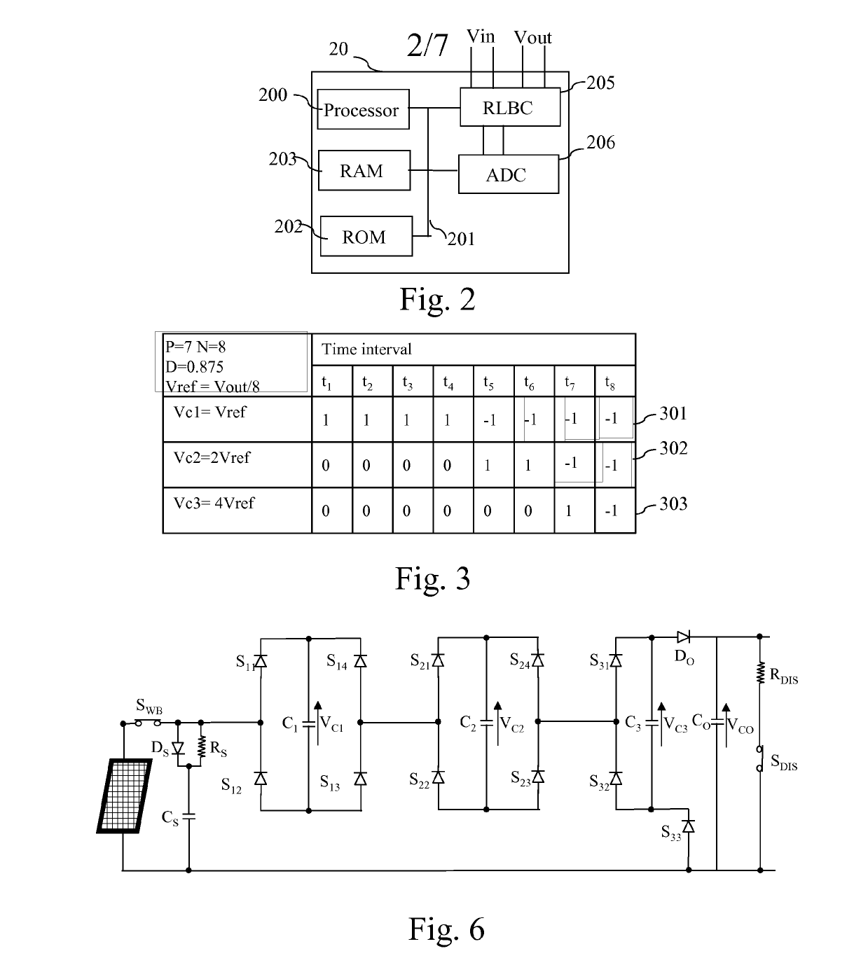

FIG. 2 represents an example of a device comprising a boost converter composed of n bridge devices;

FIG. 3 is an example of voltage values on the bridges of the boost converter composed of three bridges;

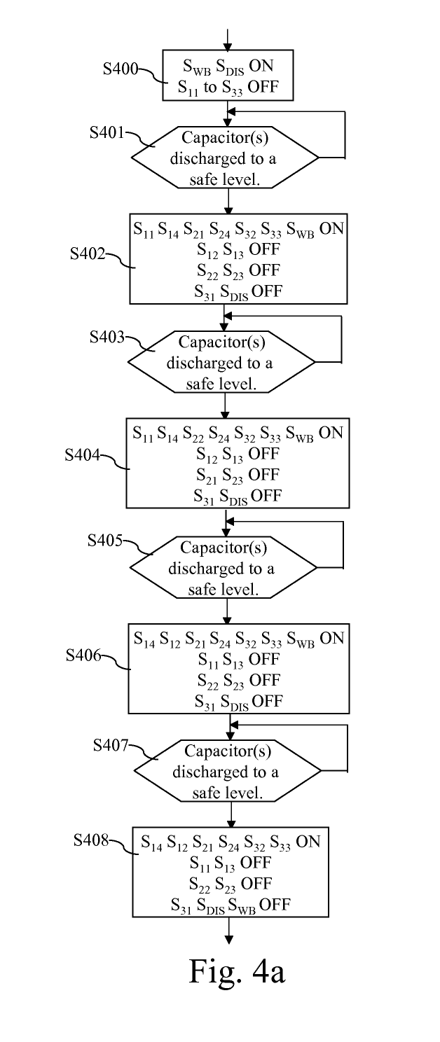

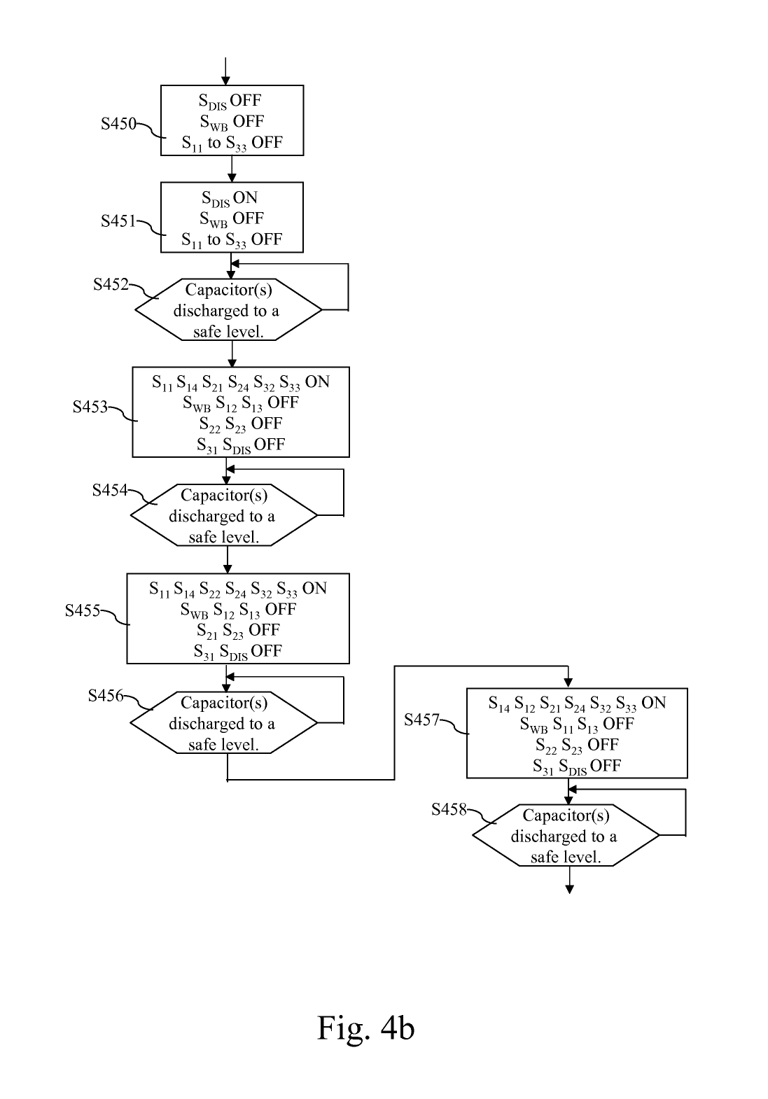

FIG. 4a is an example of an algorithm for discharging the capacitors of the boost converter composed of n for example equal to three, bridge devices described in the first example of boost converter;

FIG. 4b is an example of an algorithm for discharging the capacitors of the boost converter composed of n for example equal to three, bridge devices described in the second example of boost converter;

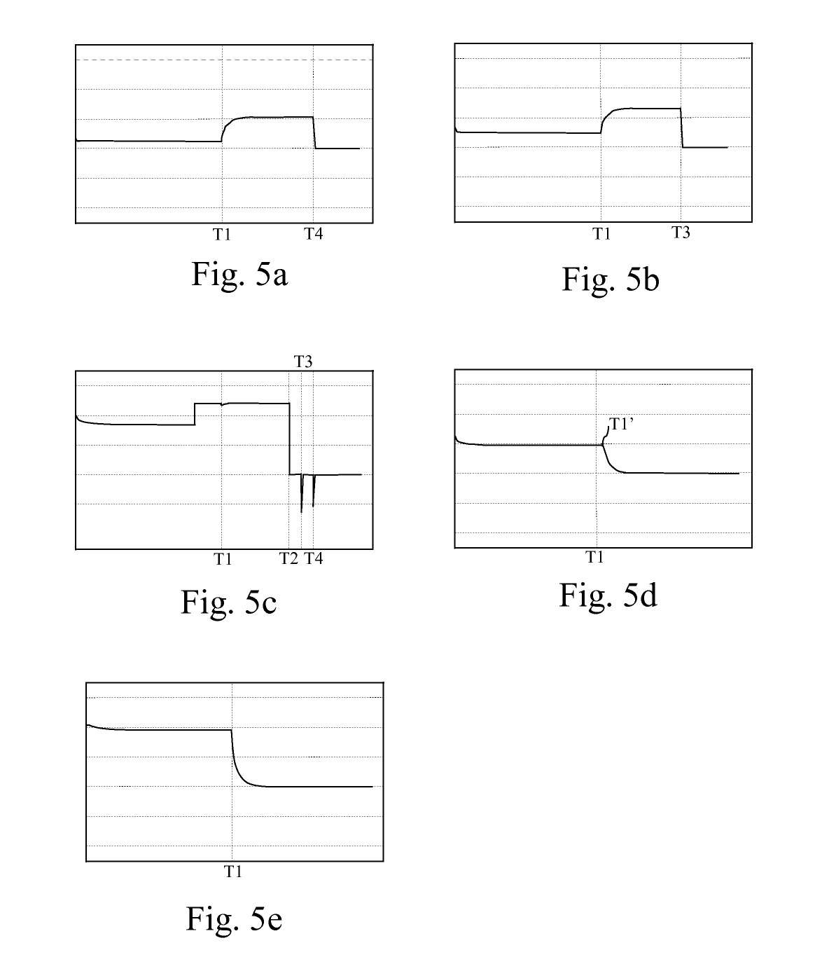

FIGS. 5 represent the voltage variations of the capacitors of the boost converter composed of three bridge devices during different periods of time for the first example of boost converter;

FIG. 6 represents the states of the switches of the boost converter composed of three bridge devices when at least one capacitor is discharged in the first configuration during the first period of time and for the first example of boost converter;

FIG. 7 represents the states of the switches of the boost converter composed of three bridge devices when at least one capacitor is discharged in the second configuration during the second period of time and for the first example of boost converter;

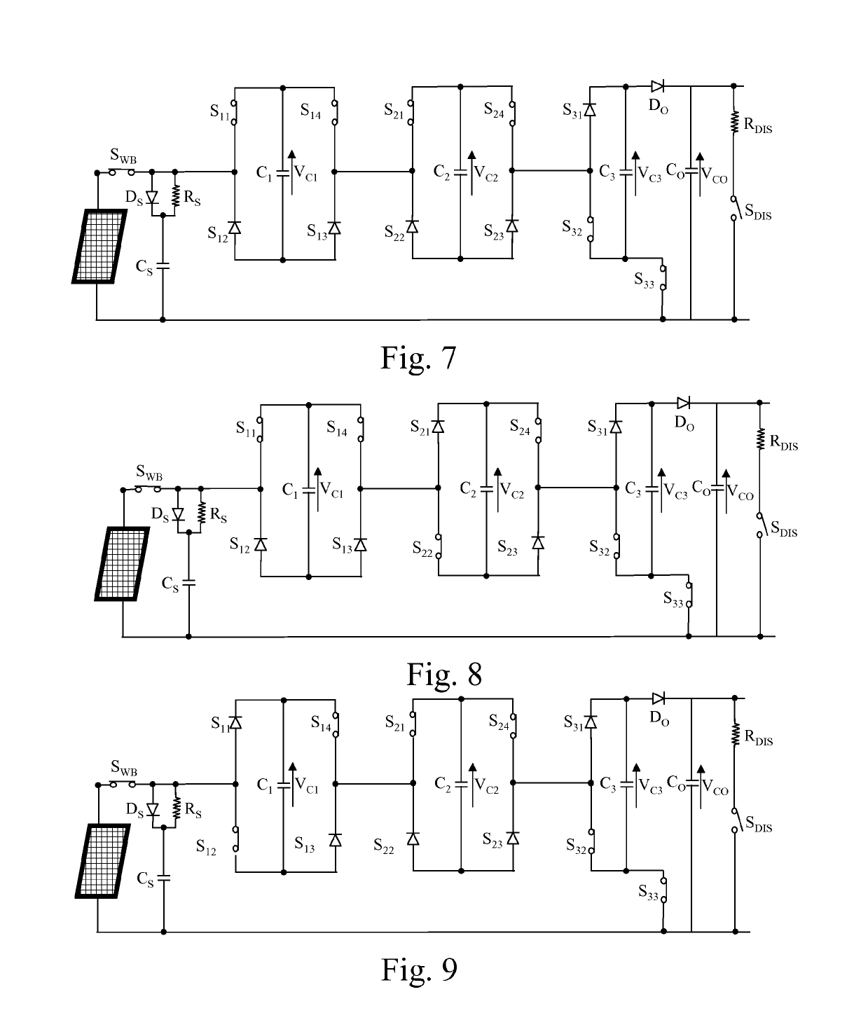

FIG. 8 represents the states of the switches of the boost converter composed of three bridge devices when at least one capacitor is discharged in the third configuration during the third period of time and for the first example of boost converter;

FIG. 9 represents the states of the switches of the boost converter composed of three bridge devices when at least one capacitor is discharged in the fourth configuration during the fourth period of time and for the first example of boost converter;

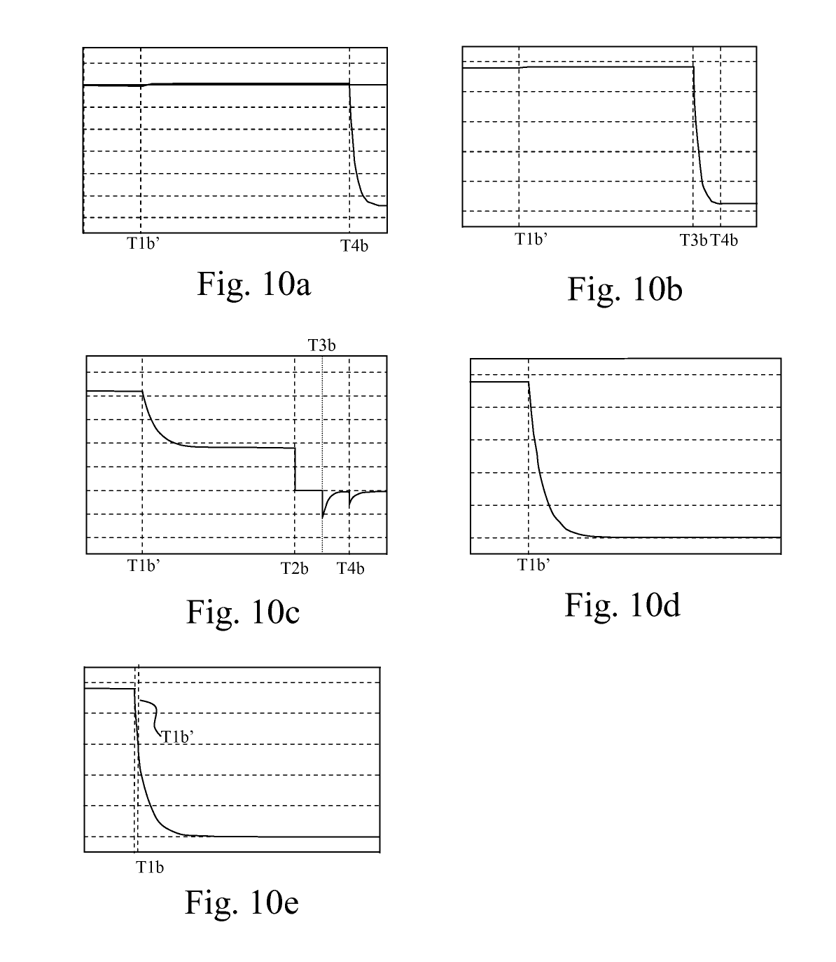

FIGS. 10 represent the voltage variations of the capacitors of the boost converter composed of three bridge devices during different periods of time for the second example of boost converter.

FIG. 1a represents a first example of a boost converter composed of three bridge devices (n=3) and wherein the electric direct current providing means are photovoltaic modules.

The boost converter composed of three bridge devices is also named Reactor Less Boost Converter (RLBC) or inductor less boost converter.

Basically, the inductor of the conventional DC/DC Boost converter is replaced by “n” bridge devices or bits connected in series. Each bridge device is composed of plural switches and a capacitor as shown in FIG. 1. It has to be noted here that two switches may be under the form of diodes acting as switches. This individual bridge structure is also named “bit”.

In the FIG. 1, each switch S₁₁, S₁₂, S₁₃, S₁₄, S₂₁, S₂₂, S₂₃, S₂₄, S₃₁, S₃₂ and S₃₃ of each bridge device or bit B1, B2 and B3 is composed of a N-MOSFET transistor and its intrinsic body diode. The anode of the body diode is connected to the source of the N-MOSFET and the cathode of the body diode is connected to the drain of the N-MOSFET transistor.

In the FIG. 1, three bits B1, B2 and B3 are shown.

A boost converter composed of a more important number of bridge devices can be obtained by duplicating the bit B1 as much as necessary.

The bit B1 is composed of four switches S₁₁, S₁₂, S₁₃ and S₁₄ and one capacitor C₁.

The bit B2 is composed of four switches S₂₁, S₂₂, S₂₃ and S₂₄ and one capacitor C₂.

The bit B3 is composed of three switches S₃₁, S₃₂, S₃₃ and one capacitor C₃.

For each bit Bi with i=1 or 2, since n=3 (i=1 to n-1), the drain of the N-MOSFET transistor of Sᵢ₁ is connected to the positive terminal of the capacitor Cᵢ and to the drain of the N-MOSFET transistor of Sᵢ₄. The source of the N-MOSFET transistor of Sᵢ₁ is connected to the drain of the N-MOSFET transistor of Sᵢ₂. The source of the N-MOSFET transistor of Sᵢ₄ is connected to the drain of the N-MOSFET transistor of Sᵢ₃. The source of the N-MOSFET transistor of Sᵢ₂ is connected to the negative terminal of the capacitor Cᵢ and to the source of the N-MOSFET transistor of Sᵢ₄.

Electric DC providing means are for example photovoltaic elements (PV module(s)) providing an input voltage Vin. The positive terminal of electric DC providing means is connected to a first terminal of a switch S_{wb}. The switch S_{wb} may be a switch controlled by a service man or a processor. The switch S_{wb} may be a circuit breaker or an interrupter or a relay or a N-MOSFET transistor.

The second terminal of the switch S_{wb} is connected to an input circuit named snubber circuit which is composed of a resistor R_{S}, a capacitor C_{S} and a diode D_{S}.

The second terminal of the switch S_{wb} is connected to the anode of the diode D_{S}, to a first terminal of the resistor R_{S} and to the drain of the N-MOSFET transistor of the switch S₁₂. The cathode of the diode D_{S} is connected to a second terminal of the resistor R_{S} and to a first terminal of the capacitor C_{S}. The second terminal of the capacitor C_{S} is connected to the negative terminal of electric DC providing means.

The source of the N-MOSFET transistor of S₁₄ is connected to the drain of the N-MOSFET transistor of S₂₂.

The source of the N-MOSFET transistor of S₂₄ is connected to the drain of the N-MOSFET transistor of S₃₂.

The source of the N-MOSFET transistor of S₃₁ is connected to the drain of the N-MOSFET transistor of S₃₂. The source of the N-MOSFET transistor of S₃₂ is connected to the negative terminal of the capacitor C₃ and to the drain of the N-MOSFET transistor of S₃₃.

The drain of the N-MOSFET transistor of S₃₁ is connected to the positive terminal of the capacitor C₃ and to the anode of a diode D_{O} of an output circuit.

The output circuit is composed of the switch S_{DIS}, the resistor R_{DIS}, the diode D_{O} and a capacitor C_{O}.

The source of the N-MOSFET transistor of S₃₃ is connected to the negative terminal of electric DC providing means.

The cathode of the diode D_{O} is connected to the positive terminal of the capacitor C_{O} and to a first terminal of the resistor R_{DIS}.

The second terminal of a discharge resistor R_{DIS} is connected to a first terminal of a switch S_{DIS}. The switch S_{DIS} may be a relay or a N-MOSFET transistor or any controllable switch.

The second terminal of a switch S_{DIS} is connected to the negative terminal of the capacitor C_{O} and to the negative terminal of electric DC providing means.

The load of the boost converter is connected between the cathode of the diode D_{O} and the negative terminal of electric DC providing means.

The voltage on the capacitor C_{O} is equal to V_{CO}, the voltage on the capacitor Cₛ is equal to V_{CS}, the voltage on the capacitor C₁ is equal to V_{C1}, the voltage on the capacitor C₂ is equal to V_{C2} and the voltage on the capacitor C₃ is equal to V_{C3}.

The voltage difference between the input and the output of B1 is named Vb1, the voltage difference between the input and the output of B2 is named Vb2 and the voltage difference between the input and the output of B3 is named Vb3. Vb3 equals Vb3* when switch S₃₃ is on, and equals Vb3** when switch S₃₃ is off.

In operation, RLBC provides discrete values of voltage step-up ratio which are dependent on the number of available “bits”. This number of discrete values of step-up ratio may respect the law:

nᵣₐₜᵢₒₛ=2ⁿ

where “nᵣₐₜᵢₒₛ” is the total number of possible step-up ratios (or duty-cycles) and “n” is the number of bits connected in series.

The voltage values imposed in each bit may respect the following law:

[Vc1_{:}Vc2_{:} . . . :Vcn]=[1:2: . . . 2⁽ⁿ⁻¹⁾]V_{CO}/2ⁿ

where V_{CO} is the stepped-up output voltage.

For obtaining a constant output voltage, it is possible to have “nᵣₐₜᵢₒₛ” different input voltages, which will respect the following law:

Vin=V_{CO}/ratioᵢ, i=1,2, . . . nᵣₐₜᵢₒₛ

For the case n=3 bits of FIG. 1, [Vc1:Vc2:Vc3]=[1:2:4]Vref.

The switching pattern of the switches of each bridge Bi is defined so as to offer a voltage Vbi at the connectors of the bridge that equals +Vci, −Vci, or 0, where Vci is the voltage of the capacitor Cᵢ. Moreover, the switching pattern of each bit Bi is timely defined as a succession of 2ⁿ equal sub periods ΔT of the main switching period T=1/f.

An example of the voltage values on the bridges of the boost converter composed of three bridge devices will be described in reference to the FIG. 3.

It has to be noted here that other configurations like [Vc1:Vc2:Vc3]=[2:3:4] or [Vc1:Vc2:Vc3:Vc3]=[1:1:1:4] may be used. Furthermore, nᵣₐₜᵢₒₛ can finally be higher than 2ⁿ.

The switching patterns are applied on the gates of the N-MOSFET transistors of the switches S₁₁, S₁₂, S₁₃, S₁₄, 5₂₁, S₂₂, S₂₃, S₂₄, S₃₁, S₃₂ and S₃₃.

According to the invention, the capacitors C₁ to Cₙ, C_{S} and C_{O} are discharged in at least n+1 periods of time.

According to the invention, the switches of the bridge devices are set in n−1 different configurations in order to discharge the capacitors of n−1 different bridge devices within n−1 consecutive periods of time.

According to the invention, the boost converter composed of three bridge devices comprises an output stage composed of at least a diode, an output capacitor, a discharge resistor and a discharge switch and the switches of the bridge devices and the discharge switch are set in a n^{th} configuration in order to discharge the output capacitor within a n^{th} time period.

According to the invention, the n^{th} configuration further enables the discharge within the n^{th} time period of the capacitor of the n^{th} bridge device.

According to the invention, the boost converter composed of three bridge devices further comprises an input stage composed of at least an input diode, an input capacitor and an input resistor and the switches of the bridge devices and the discharge switch are set in a (n+1)^{th} configuration in order to discharge the input capacitor within a (n+1)^{th} time period.

According to the invention, the n^{th} configuration is set as first, followed by the (n+1)^{th} configuration and followed by the n−1 different configurations.

FIG. 1b represents a second example of a boost converter composed of three bridge devices and wherein the electric direct current providing means are any kind of electric DC power sources.

The second example of the boost converter composed of three bridge devices is almost identical to the first example of the converters.

The second example of the converter is composed of the same electric diagram and the same components S₁₁, S₁₂, S₁₃, S₁₄, S₂₁, S₂₂, S₂₃, S₂₄, S₃₁, S₃₂, S₃₃, S_{DIS}, S_{WB C}₁, C₂, C₃, C_{O}, C_{S}, R_{DIS}, R_{S}, D_{S}, D_{O} and further comprises a discharging circuit.

The additional discharging circuit is composed of a discharge diode D_{DIS} and a second discharge resistor R_{DIS′}.

The cathode of the discharge diode D_{DIS} is connected to the input, composed of the source of the N-MOSFET transistor of S₁₁ connected to the drain of the N-MOSFET transistor of S₁₂, of first bridge device B1. The anode of the discharge diode D_{DIS} is connected to a first terminal of the second discharge resistor R_{DIS′} and the second terminal of the second discharge resistor R_{DIS′} is connected to the negative terminal of the electric direct current providing means.

If the electric direct current providing means have a protection diode in which the cathode is connected to the positive terminal of the electric direct current providing means and the anode is connected to the negative terminal of the electric direct current providing means, a huge current flows through the protection diode during the discharge of C₂ or C₁ if the switch S_{WB} is in conduction mode. This current may destroy the protection diode or the capacitors or the other switches of the boost converter composed of three bridge devices.

The discharging circuit enables the discharge of the capacitors C₁ and C₂ when the switch S_{WB} is not conducting and limits the discharge currents thanks to the selection of a proper value of the second resistor R_{DIS′}.

FIG. 2 represents an example of a device comprising a boost converter composed of three bridge devices.

The device 20 has, for example, an architecture based on components connected together by a bus 201 and a processor 200 controlled by the program related to the algorithm as disclosed in the FIG. 4a or 4b.

It has to be noted here that the device 20 is, in a variant, implemented under the form of one or several dedicated integrated circuits which execute the same operations as the one executed by the processor 200 as disclosed hereinafter.

The bus 201 links the processor 200 to a read only memory ROM 202, a random access memory RAM 203, an analogue to digital converter ADC 206 and the RLBC module as the one disclosed in FIG. 1a or 1b.

The read only memory ROM 202 contains instructions of the program related to the algorithm as disclosed in the FIG. 4a or 4b which are transferred, when the device 20 is powered on to the random access memory RAM 203.

The read only memory ROM 202 memorizes tables as the one shown in FIG. 3 during the normal operation of the boost converter composed of three bridge devices and also the switching patterns corresponding to the first, second, third and fourth configuration of the switches of the RLBC during the discharge process.

The RAM memory 203 contains registers intended to receive variables, and the instructions of the program related to the algorithm as disclosed in the FIG. 4a or 4b.

The analogue to digital converter 206 is connected to the RLBC and converts voltages representative of the input voltage Vin and/or the output voltage Vout=V_{CO} into binary information.

FIG. 3 is an example of voltage values on the bridges of the boost converter composed of three bridges in order to have a ratio V_{CO}/Vin=N/(N−P)=8(D=0.875).

The periodical pattern used when the RLCB boosts the electric DC providing means is decomposed into eight time intervals. The reference voltage Vref equals Vout divided by eight.

In the line 301, a value which is equal to 1 means that Vb1=Vref, a value which is equal to −1 means Vb1=−Vref and a value which is equal to 0 means Vb1=0.

In the line 302, a value which is equal to 1 means that Vb2=2Vref, a value which is equal to −1 means Vb2=−2Vref and a value which is equal to 0 means Vb2=0.

In the line 303, a value which is equal to 1 means that Vb3=4Vref, a value which is equal to −1 means Vb3=−4Vref and a value which is equal to 0 means Vb3=0.

The duration of each time interval t₁ to t₈ is ΔT=T/N (N=8), where T is the duration of the cycle operated by switch S₃₃ of FIG. 1.

Eight time intervals are needed in order to get a ratio Vout/Vin=8.

At time intervals t₁, t₂, t₃ and t₄, Vb1=Vref, Vb2=Vb3=0. At time intervals t₅ and t₆, Vb1=−Vref, Vb2=2Vref and Vb3=0. At time interval t₇, Vb1=−Vref, Vb2=−2Vref and Vb3=4Vref. At time interval t₈, Vb1=−Vref, Vb2=−2Vref and Vb3=−4Vref.

FIG. 4a is an example of an algorithm for discharging the capacitors of the first example of the boost converter composed of n, for example equal to three, bridge devices.

More precisely, the present algorithm is executed by the processor 200 of the device 20 comprising a boost converter composed of n bridge devices.

The present algorithm is executed each time the RLBC needs to be powered off for example for maintenance purpose or when the RLBC needs to be set in known initial conditions.

At step S400, the processor 200 sets the switches of the RLBC in the first configuration. In the first configuration, the processor 200 commands the switches of the RLBC in order to set the switches S₁₁ to S₃₃ to OFF state, i.e. to put the N-MOSFET transistors of the switches S₁₁, S₁₂, S₁₃, S₁₄, S₂₁, S₂₂, S₂₃, S₂₄, S₃₁, S₃₂ and S₃₃ in a non conductive mode. In the first configuration, the processor 200 commands the switches of the RLBC in order to set the switch S_{DIS} to ON state, i.e. to conduction state and the switch S_{WB} is kept to ON state.

The first configuration of the RLBC corresponds to the electric circuit shown in FIG. 6.

FIG. 6 represents the states of the switches of the boost converter composed of three bridge devices when at least one capacitor is discharged in the first configuration during the first period of time and for the first example of boost converter.

As the N-MOSFET transistors of the switches S₁₁ to S₃₃ are in a non conductive mode, currents may flow or not in the body diodes of the switches S₁₁ to S₃₃ according to their polarities.

In the first period of time, which starts at T1, the capacitors C₃ and C_{O} are discharged as shown in FIGS. 5d and 5e and the capacitors C₁, C₂ and C_{S} are not discharged as shown in FIGS. 5a, 5b and 5c.

FIG. 5a represents the voltage variations V_{C1} for the capacitor C₁ of the boost converter composed of three bridge devices during the different periods of time and for the first example of boost converter.

FIG. 5b represents the voltage variations V_{C2} for the capacitor C₂ of the boost converter composed of three bridge devices during the different periods of time and for the first example of boost converter.

FIG. 5c represents the voltage variations V_{CS} for the capacitor C_{S} of the boost converter composed of three bridge devices during the different periods of time and for the first example of boost converter.

FIG. 5d represents the voltage variations V_{C3} for the capacitor C₃ of the boost converter composed of three bridge devices during the different periods of time and for the first example of boost converter.

FIG. 5e represents the voltage variations V_{CO} for the capacitor C_{O} of the boost converter composed of three bridge devices during the different periods of time and for the first example of boost converter.

Time T1 corresponds to the instant of the command of the switches in the first configuration executed at step S400.

As shown in FIG. 5e, after T1, capacitor C_{O} is discharged through resistor R_{DIS}. The other voltages in FIGS. 5a to 5d V_{C1}, V_{C2}, V_{C3} and V_{CS} don't change until the value of V_{CO}+V_{C1}+V_{C2} becomes equal to Vin=V_{CS}.

From this time instant V_{C1} and V_{C2} will start being charged through the body diodes of S₁₁, S₁₃, S₂₁ and S₂₃. This charging process will last until V_{CO} is completely discharged and Vin=V_{C1}+V_{C2}=V_{OC} where V_{OC} is the voltage Vin when no current is supplied by the power source, meaning the open-circuit voltage of a photovoltaic module. During the first period of time, in a certain moment in FIG. 5d, V_{CO}=V_{C3} and from T1′ both capacitors C_{O} and C₃ are discharged together, since the body diode of S₃₃ also becomes conductive. Since both voltages V_{CO} and V_{C3} are monitored, when V_{CO}=V_{C3}, the N-MOSFET S₃₃ can be set in the ON state in order to avoid to stress its body diode. At the end of the first period of time V_{CO}=V_{C3}=0 and Vin=V_{CS}=V_{OC}=V_{C1}+V_{C2}.

At next step S401, the processor 200 checks if it is time to change the capacitor to be discharged, i.e. if the first period of time elapsed.

If it is time to change the capacitor to be discharged, the processor 200 moves to step S402. Otherwise, the processor 200 returns to step S401.

The processor 200 may check if it is time to change the capacitor to be discharged by checking if the voltages V_{CO} and V_{C3} are equal or lower than 2 volts or by checking if a timer activated at step S400 which is representative of the first period of time is at least upper than a predetermined value determined according to the values of capacitors C_{O}, C₃ and resistor R_{DIS}.

At step S402, the processor 200 sets the switches of the RLBC in the second configuration. In the second configuration, the processor 200 commands the switches of the RLBC in order to set the switches S_{WB}, S₁₁, S₁₄, S₂₁, S₂₄, S₃₂ and S₃₃ to ON state, i.e. to put the N-MOSFET transistors of the switches S₁₁, S₁₄, S₂₁, S₂₄, S₃₂ and S₃₃ in the conductive mode. The processor 200 commands the switches of the RLBC in order to set the switches S₁₂, S₁₃, S₂₂, S₂₃, S₃₁ and S_{DIS} to OFF state, i.e. to put the N-MOSFET transistors of the switches S₁₂, S₁₃, S₂₂, S₂₄, S₂₃, S₃₁ in the non conductive mode.

The second configuration of the RLBC corresponds to the electric circuit shown in FIG. 7.

FIG. 7 represents the states of the switches of the boost converter composed of three bridge devices when at least one capacitor is discharged in the second configuration during the second period of time and for the first example of boost converter.

As the N-MOSFET transistors of the switches S₁₁, S₁₄, S₂₁, S₂₄, S₃₂ and S₃₃ are in the conductive mode, the switches S₁₁, S₁₄, S₂₁, S₂₄, S₃₂ and S₃₃ are represented by shunts.

Within the second period of time, capacitor C_{S} is discharged through resistor R_{S}, since the snubber circuit is short-circuited to the ground through the conducting N-MOSFETs S₁₁, S₁₄, S₂₁, S₂₄, S₃₂ and S₃₃.

When the electric DC providing means are photovoltaic modules, Vin will change instantly to zero and the photovoltaic module is forced to the short-circuit current I_{SC} condition. Capacitor C_{S} will discharge according to the snubber circuit time-constant and the current peak will be limited to V_{CS}/R_{S}. At the end of this second time interval, capacitor C_{S} is completely discharged.

FIG. 5c represents the voltage variations V_{CS} for the capacitor C_{S} of the boost converter composed of three bridge devices during the different periods of time and for the first example of boost converter.

Time T1 corresponds to the instant of the command of the switches in the first configuration executed at step S400.

Time T2 corresponds to the instant of the command of the switches in the second configuration executed at step S402.

Times T3 and T4 correspond to the instant of the command of the switches in the third and fourth configurations which will be disclosed at steps S404 and S406 of the present algorithm.

At next step S403, the processor 200 checks if it is time to change the capacitor to be discharged, i.e. if the second period of time is elapsed.

If it is time to change the capacitor to be discharged, the processor 200 moves to step S404. Otherwise, the processor 200 returns to step S403.

The processor 200 may check if it is time to change the capacitor to be discharged by checking if the voltage V_{CS}≦2 volts or by checking if a timer activated at step S402 is at least upper than a predetermined value determined according to the values of capacitor C_{S} and resistor R_{S}.

At step S404, the processor 200 sets the switches of the RLBC in the third configuration. In the third configuration, the processor 200 commands the switches of the RLBC in order to set the switches S_{WB}, S₁₁, S₁₄, S₂₂, S₂₄, S₃₂ and S₃₃ to ON state, i.e. to put the N-MOSFET transistors of the switches S₁₁, S₁₄, S₂₂, S₂₄, S₃₂ and S₃₃ in the conductive mode. The processor 200 commands the switches of the RLBC in order to set the switches S₁₂, S₁₃, S₂₁, S₂₃, S₃₁ and S_{DIS} to OFF state, i.e. to put the N-MOSFET transistors of the switches S₁₂, S₁₃, S₂₁ and S₂₃, S₃₁ in the non conductive mode.

The third configuration of the RLBC corresponds to the electric circuit shown in FIG. 8.

FIG. 8 represents the states of the switches of the boost converter composed of three bridge devices when at least one capacitor is discharged in the third configuration during the third period of time and for the first example of boost converter.

As the N-MOSFET transistors of the switches S₁₁, S₁₄, S₂₂, S₂₄, S₃₂ and S₃₃ are in the conductive mode, the switches S₁₁, S₁₄, S₂₂, S₂₄, S₃₂ and S₃₃ are represented by shunts.

In the third period of time, V_{C2} is discharged almost in the same manner as V_{CS}.

FIG. 5b represents the voltage variations V_{C2} for the capacitor C₂ of the boost converter composed of three bridge devices during the different periods of time for the first example of boost converter.

Time T1 corresponds to the instant of the command of the switches in the first configuration executed at step S400.

Time T3 corresponds to the instant of the command of the switches in the third configuration executed at step S404.

When the electric DC providing means are photovoltaic modules without protection diodes, V_{C2} is applied to the photovoltaic module, meaning that there will be a negative voltage on the photovoltaic module that will last until the moment in which the capacitor C₂ is completely discharged. The current through the capacitor C₂ will be I_{SC} (photovoltaic module short-circuit current) plus the component through the resistor R_{S} and with a current peak limited to I_{SC}+V_{C2}/R_{S}.

That negative voltage appears also on capacitor C_{S} as it is shown at T3 in the FIG. 5c.

At next step S405, the processor 200 checks if it is time to change the capacitor to be discharged, i.e. if the third period of time is elapsed.

If it is time to change the capacitor to be discharged, the processor 200 moves to step S406. Otherwise, the processor 200 returns to step S405.

The processor 200 may check if it is time to change the capacitor to be discharged by checking if the voltage V_{C2}≦2 volts or by checking if a timer activated at step S404 is at least upper than a predetermined value determined according to the values of capacitor C₂ and resistor R_{S}.

At step S406, the processor 200 sets the switches of the RLBC in the fourth configuration. In the fourth configuration, the processor 200 commands the switches of the RLBC in order to set the switches S_{WB}, S₁₄, S₁₂, S₂₁, S₂₄, S₃₂ and S₃₃ to ON state, i.e. to put the N-MOSFET transistors of the switches S₁₄, S₁₂, S₂₁, S₂₄, S₃₂ and S₃₃ in the conductive mode. In the fourth configuration, the processor 200 commands the switches of the RLBC in order to set the switches S₁₁, S₁₃, S₂₂, S₂₃, S₃₁ and S_{DIS} to OFF state, i.e. to put the N-MOSFET transistors of the switches S₁₁, S₁₃, S₂₂, S₂₃, S₃₁ in the non conductive mode.

The fourth configuration of the RLBC corresponds to the electric circuit shown in FIG. 9.

FIG. 9 represents the states of the switches of the boost converter composed of three bridge devices when at least one capacitor is discharged in the fourth configuration during the fourth period of time and for the first example of boost converter.

As the N-MOSFET transistors of the switches S₁₄, S₁₂, S₂₁, S₂₄, 5₃₂ and S₃₃ are in the conductive mode, the switches S₁₄, S₁₂, S₂₁, 5₂₄, 5₃₂ and S₃₃ are represented by shunts.

In the fourth period of time, C₁ is discharged in the same manner as C₂.

FIG. 5a represents the voltage variations V_{C1} for the capacitor C₁ of the boost converter composed of three bridge devices during the different periods of time for the first example of boost converter.

Time T1 corresponds to the instant of the command of the switches in the first configuration executed at step S400.

Time T4 corresponds to the instant of the command of the switches in the fourth configuration executed at step S406.

When the electric DC providing means are photovoltaic modules, V_{C1} is applied to the photovoltaic module, meaning that there will be a negative voltage on the photovoltaic module that will last until the moment in which the capacitor C₁ is completely discharged. The current through the capacitor will be I_{SC} plus the component through resistor R_{S} and with a current peak limited to I_{SC}+V_{C1}/R_{S}.

That negative voltage appears also on capacitor C_{S} as it is shown at T3 in the FIG. 5c.

At next step S407, the processor 200 checks if it is time to change the capacitor to be discharged.

If it is time to change the capacitor to be discharged, the processor 200 moves to step S408. Otherwise, the processor 200 returns to step S407.

The processor 200 may check if it is time to change the capacitor to be discharged by checking if the voltage V_{C1}≦2 volts or by checking if a timer activated at step S406 is at least upper than a predetermined value determined according to the values of C₁ and R_{S}.

At next step S408, the switch S_{WB} is put in OFF state.

It has to be noted here that, in a variant, the steps S406 and S407 can be executed prior to the step S404.

Furthermore, when the RLBC is composed of a more important number of bits, for example one more bit, the present algorithm comprises two more steps for each supplementary bit, which enable the discharge of the capacitor of each supplementary bit.

FIG. 4b is an example of an algorithm for discharging the capacitors of the second example of the boost converter composed of three bridge devices.

More precisely, the present algorithm is executed by the processor 200 of the device 20 comprising a boost converter composed of n, for example equal to three, bridge devices.

The present algorithm is executed each time the RLBC needs to be powered off for example for maintenance purpose or when the RLBC needs to be set in known initial conditions.

At step S450, the processor 200 commands the switches of the RLBC in order to set the switches S₁₁ to S₃₃ to OFF state, i.e. to put the N-MOSFET transistors of the switches S₁₁, S₁₂, S₁₃, S₁₄, S₂₁, S₂₂, S₂₃, S₂₄, S₃₁, S₃₂ and S₃₃ in a non conductive mode. The processor 200 commands the switches of the RLBC in order to set the switches S_{WB} and S_{DIS} to OFF state, i.e. to non conduction state.

Thus, the RLBC is disconnected from the load and from the electric direct current providing means which can be a voltage source, a current source or a photovoltaic module using or not the anti-parallel protection diode. All capacitors C_{S}, C₁, C₂, C₃ and C_{O} of the RLBC are kept charged since there is no current path for their discharge.

At step S451, the processor 200 sets the switches of the RLBC in the first configuration. In the first configuration, the processor 200 commands the switches of the RLBC in order to set the switches S₁₁ to S₃₃ to OFF state, i.e. to put the N-MOSFET transistors of the switches S₁₁, S₁₂, S₁₃, S₁₄, S₂₁, S₂₂, S₂₃, S₂₄, S₃₁, in a non conductive mode. In the first configuration, the processor 200 commands the switches of the RLBC in order to set the switch S_{WB} to OFF state and the switch S_{DIS} to ON state, i.e. to conduction state.

During the first period of time, the capacitor C_{O} starts to be discharged through R_{DIS}. The first configuration of the RLBC is set for a first period of time, which starts at T1b as shown in FIG. 10e.

FIG. 10e represents the voltage variations V_{CO} for the capacitor C_{O} of the boost converter composed of three bridge devices during the different periods of time and for the second example of boost converter.

At time T1b′ the voltage level of capacitor C₃ becomes equal to the voltage level of capacitor C_{O}. In this way, the body diode of S₃₃ and also the diode D_{O} become conductive, and from this time instant both capacitors are discharged through resistor R_{DIS}. The capacitor C_{S} starts also to be discharged through the body diodes of the switches S₁₁, S₁₃, S₂₁, S₂₃, S₃₁ and D_{O}, and consequently also through capacitors C₁, C₂ and resistor R_{S}. This phase lasts until capacitors C_{O} and C₃ are completely discharged, and so, V_{CS}, V_{C1} and V_{C2} will be under equilibrium and there will be no current through them anymore.

These behaviors are disclosed in FIGS. 10a to 10e.

FIG. 10a represents the voltage variations V_{C1} for the capacitor C₁ of the boost converter composed of three bridge devices during the different periods of time and for the second example of boost converter.

FIG. 10b represents the voltage variations V_{C2} for the capacitor C₂ of the boost converter composed of three bridge devices during the different periods of time and for the second example of boost converter.

FIG. 10c represents the voltage variations V_{CS} for the capacitor Cₛ of the boost converter composed of three bridge devices during the different periods of time and for the second example of boost converter.

FIG. 10d represents the voltage variations V_{C3} for the capacitor C₃ of the boost converter composed of three bridge devices during the different periods of time and for the second example of boost converter.

At next step S452, the processor 200 checks if it is time to change the capacitor to be discharged, i.e. if the first period of time elapsed.

If it is time to change the capacitor to be discharged, the processor 200 moves to step S453. Otherwise, the processor 200 returns to step S452.

The processor 200 may check if it is time to change the capacitor to be discharged by checking if the voltages V_{CO} and V_{C3} are equal or lower than 2 volts or by checking if a timer activated at step S451 which is representative of the first period of time is at least upper than a predetermined value determined according to the values of capacitors C_{O}, C₃ and resistor R_{DIS}.

At step S453, the processor 200 sets the switches of the RLBC in the second configuration. In the second configuration, the processor 200 commands the switches of the RLBC in order to set the switches S₁₁, S₁₄, S₂₁, S₂₄, S₃₂ and S₃₃ to ON state, i.e. to put the N-MOSFET transistors of the switches S₁₁, S₁₄, S₂₁, S₂₄, S₃₂ and S₃₃ in the conductive mode. The processor 200 commands the switches of the RLBC in order to set the switches S_{WB}, S₁₂, S₁₃, S₂₂, S₂₃, S₃₁ and S_{DIS} to OFF state, i.e. to put the N-MOSFET transistors of the switches S₁₂, S₁₃, S₂₂, S₂₄, S₂₃, S₃₁ in the non conductive mode.

Within the second period of time, capacitor C_{S} is discharged through resistor R_{S}, since the snubber circuit is short-circuited to the ground through the conducting N-MOSFET of S₁₁, S₁₄, S₂₁, S₂₄, S₃₂ and S₃₃.

FIG. 10C represents the voltage variations V_{CS} for the capacitor C_{S} of the boost converter composed of three bridge devices during the different periods of time and for the second example of boost converter.

Time T1b′ corresponds to the instant in which C_{S} starts to be discharged after the command of the switches in the first configuration executed at step S451.

Time T2b corresponds to the instant of the command of the switches in the second configuration executed at step S453.

Times T3b and T4b correspond to the instant of the command of the switches in the third and fourth configurations which will be disclosed at steps S455 and S457 of the present algorithm.

At next step S454, the processor 200 checks if it is time to change the capacitor to be discharged, i.e. if the second period of time is elapsed.

If it is time to change the capacitor to be discharged, the processor 200 moves to step S455. Otherwise, the processor 200 returns to step S454.

The processor 200 may check if it is time to change the capacitor to be discharged by checking if the voltage V_{CS}≦2 volts or by checking if a timer activated at step S453 is at least upper than a predetermined value determined according to the values of capacitor C_{S} and resistor R_{S}.

At step S455, the processor 200 sets the switches of the RLBC in the third configuration. In the third configuration, the processor 200 commands the switches of the RLBC in order to set the switches S₁₁, S₁₄, S₂₂, S₂₄, S₃₂ and S₃₃ to ON state, i.e. to put the N-MOSFET transistors of the switches S₁₁, S₁₄, S₂₂, S₂₄, S₃₂ and S₃₃ in the conductive mode. The processor 200 commands the switches of the RLBC in order to set the switches S_{WB}, S₁₂, S₁₃, S₂₁, S₂₃, S₃₁ and S_{DIS} to OFF state, i.e. to put the N-MOSFET transistors of the switches S₁₂, S₁₃, S₂₁ and S₂₃, S₃₁ in the non conductive mode.

In the third period of time, V_{C2} is discharged almost in the same manner as V_{CS}.

FIG. 10b represents the voltage variations V_{C2} for the capacitor C₂ of the boost converter composed of three bridge devices during the different periods of time for the second example of boost converter.

Time T3b corresponds to the instant of the command of the switches in the third configuration executed at step S455.

Time T4b corresponds to the instant of the command of the switches in the fourth configuration executed at step S457.

The capacitor C₂ is discharged through D_{DIS} and R_{DIS}′ and also through resistor R_{S} and capacitor C_{S}. Capacitor C_{S} experiments an initial negative voltage imposed by capacitor C₂, being then discharged simultaneously to it, up to the complete discharge of both capacitors C₂ and C_{S}. That negative voltage appears also on capacitor C_{S} as it is shown at T3b in the FIG. 10c.

At next step S456, the processor 200 checks if it is time to change the capacitor to be discharged, i.e. if the third period of time is elapsed.

If it is time to change the capacitor to be discharged, the processor 200 moves to step S457. Otherwise, the processor 200 returns to step S456.

The processor 200 may check if it is time to change the capacitor to be discharged by checking if the voltage V_{C2}≦2 volts or by checking if a timer activated at step S455 is at least upper than a predetermined value determined according to the values of capacitors C₂ and C_{S} and resistors R_{S} and R_{DIS}′.

At step S457, the processor 200 sets the switches of the RLBC in the fourth configuration. In the fourth configuration, the processor 200 commands the switches of the RLBC in order to set the switches S₁₄, S₁₂, S₂₁, S₂₄, S₃₂ and S₃₃ to ON state, i.e. to put the N-MOSFET transistors of the switches S₁₄, S₁₂, S₂₁, S₂₄, S₃₂ and S₃₃ in the conductive mode. In the fourth configuration, the processor 200 commands the switches of the RLBC in order to set the switches S_{WB}, S₁₁, S₁₃, S₂₂, S₂₃, S₃₁ and S_{DIS} to OFF state, i.e. to put the N-MOSFET transistors of the switches S₁₁, S₁₃, S₂₂, S₂₃, S₃₁ in the non conductive mode.

In the fourth period of time, V_{C1} is discharged in the same manner as V_{C2}.

FIG. 10a represents the voltage variations V_{C1} for the capacitor C₁ of the boost converter composed of three bridge devices during the different periods of time for the second example of boost converter.

Time T4b corresponds to the instant of the command of the switches in the fourth configuration executed at step S457.

The capacitor C₁ is discharged through D_{DIS} and R_{DIS′} and also through resistor R_{S} and capacitor C_{S}. Capacitor C_{S} experiments an initial negative voltage imposed by capacitor C₂, being then discharged simultaneously to it, up to the complete discharge of both capacitors C₂ and C_{S}. That negative voltage appears also on capacitor C_{S} as it is shown at T4b in the FIG. 10c.

At next step S458, the processor 200 checks if it is time to change the capacitor to be discharged.

If it is time to change the capacitor to be discharged, the processor 200 interrupts the present algorithm. Otherwise, the processor 200 returns to step S458.

The processor 200 may check if it is time to change the capacitor to be discharged by checking if the voltage V_{C1}≦2 volts or by checking if a timer activated at step S457 is at least upper than a predetermined value determined according to the values of capacitors C₁ and C_{S} and resistors R_{S} and R_{DIS′}.

It has to be noted here that, when the RLBC is composed of a more important number of bits, for example one more bit, the present algorithm comprises two more steps for each supplementary bit, which enable the discharge of the capacitor of each supplementary bit.

Naturally, many modifications can be made to the embodiments of the invention described above without departing from the scope of the present invention.

1-13. (canceled)

14. Method for discharging the capacitors of a boost converter in order to set the boost converter in a configuration avoiding shock hazard or to set initial conditions for the boost converter, the boost converter being composed of a number n of bridge devices connected in series, the boost converter composed of n bridge devices being connected to electric direct current providing means, each bridge device being composed of plural switches and a capacitor, wherein the first bridge is connected to one terminal of the electric direct current providing means and only the n^{th} bridge is connected to the other terminal of the direct current providing means, the method comprises:
setting the switches of the bridge devices in n−1 different configurations in order to provide a path allowing each of the n−1 capacitors of the n−1 different bridge devices to be discharged within a respective periods of time.

15. Method according to claim 14, wherein the boost converter composed of n bridge devices comprises an output stage composed of at least a diode, an output capacitor, a discharge resistor and a discharge switch, the method further comprises:
setting the switches of the bridge devices and the discharge switch in a n^{th} configuration in order to discharge the output capacitor within a n^{th} time period.

16. Method according to claim 15, wherein the n^{th} configuration further enables the discharge within the n^{th} time period of the capacitor of the n^{th} bridge device.

17. Method according to claim 14, wherein the boost converter composed of n bridge devices further comprises an input stage composed of at least an input diode, an input capacitor and an input resistor, the method further comprises:
setting the switches of the bridge devices and the discharge switch in a (n+1)^{th} configuration in order to discharge the input capacitor within a (n+1)^{th} time period.

18. Method according to claim 17, wherein the n^{th} configuration is set as first, followed by the (n+1)^{th} configuration and followed by the other n−1 different configurations.

19. Apparatus for discharging the capacitors of a boost converter in order to set the boost converter in a configuration avoiding shock hazard or to set initial conditions for the boost converter, the boost converter being composed of a number n of bridge devices connected in series, the boost converter composed of n bridge devices being connected to electric direct current providing means, each bridge device being composed of plural switches and a capacitor, wherein the first bridge is connected to one terminal of the electric direct current providing means and only the n^{th} bridge is connected to the other terminal of the direct current providing means, the apparatus comprises :
means for setting the switches of the bridge devices in n−1 different configurations in order to provide a path allowing each of the n−1 capacitors of the n−1 different bridge devices to be discharged within a respective periods of time.

20. Apparatus according to claim 19, wherein the boost converter composed of n bridge devices further comprises an output stage composed of at least a diode, an output capacitor, a discharge resistor and a discharge switch, the apparatus further comprises:
means for setting the switches of the bridge devices and the discharge switch in a n^{th} configuration in order to discharge the output capacitor within a n^{th} time period.

21. Apparatus according to claim 20, wherein the n^{th} configuration further enables the discharge within the n^{th} time period of the capacitor of the n^{th} bridge device.

22. Apparatus according to claim 19, wherein the boost converter composed of n bridge devices further comprises an input stage composed of at least an input diode, an input capacitor and an input resistor, the apparatus further comprises of:
means for setting the switches of the bridge devices and the discharge switch in a (n+1)^{th} configuration in order to discharge the input capacitor within a (n+1)^{th} time period.

23. Apparatus according to claim 19, wherein the electric direct current providing means are photovoltaic modules.

24. Apparatus according to claim 23, wherein the boost converter composed of n bridge devices further comprises a switch connecting the photovoltaic modules and the input stage and the switch connecting the photovoltaic modules and the input stage is in conducting state during the n+1 configurations.

25. Apparatus according to claim 19, wherein the boost converter composed of n bridge devices further comprises a switch connecting the electric direct current providing means and the input stage and in that the switch connecting the electric direct current providing means and the input stage is in a non conducting state during the n+1 configurations.

26. Apparatus according to claim 25, wherein the boost converter composed of n bridge devices further comprises a discharge circuit connected between the switch connecting the electric direct current providing means and a first bridge device, the discharge circuit being composed of a discharge diode and a second discharge resistor, the cathode of the discharge diode being connected to the input of the first bridge device, the anode of the discharge diode being connected to the first terminal of the second discharge resistor and the second terminal of the second discharge resistor being connected to the negative terminal of the electric direct current providing means.
